(19) United States
(12) Patent Application Publication
(10) Pub. No.: US 2024/0071153 A1
(43) Pub. Date: Feb. 29, 2024

(54) APPARATUS AND METHOD FOR GENERATING LOG DATA

(71) Applicants: HYUNDAI MOTOR COMPANY, Seoul (KR); Kia Corporation, Seoul (KR)

(72) Inventors: Sun Ho CHOI, Hwaseong-si (KR); Hyun Wook KIM, Seoul (KR)

(73) Assignees: HYUNDAI MOTOR COMPANY, Seoul (KR); Kia Corporation, Seoul (KR)

(21) Appl. No.: 18/097,888

(22) Filed: Jan. 17, 2023

(30) Foreign Application Priority Data
Aug. 26, 2022 (KR) 10-2022-0107754

(51) Int. Cl. G07C 5/08

(52) U.S. Cl. CPC G07C 5/085; G07C 5/0816

(57) ABSTRACT

An apparatus and a method for generating log data includes a controller that monitors input data and output data corresponding to the input data with respect to a control device of a vehicle, and when there is a change in current output data compared to previous output data, generates log data based on the input data and the current output data and a memory that stores the generated log data.

### CROSS-REFERENCE TO RELATED APPLICATION

The present application claims priority to Korean Patent Application No. 10-2022-0107754, filed on Aug. 26, 2022, the entire contents of which is incorporated herein for all purposes by this reference.

### BACKGROUND OF THE PRESENT DISCLOSURE

### Field of the Present Disclosure

The present disclosure relates to a technology for efficiently generating log data of a control device provided in a vehicle.

### Description of Related Art

In general, it is important how valuable data is stored in a limited memory for logging of data occurring in a vehicle. On the other hand, there are many input/output variables because the vehicle includes various control devices, and data omission may occur depending on persons who design logging logics due to various usage patterns of customers. As a result, various usage patterns may be considered and it may be determined differently which input data and output data should be stored depending on a designer's experience. Therefore, log data omission may occur, and logging itself may not be performed for intermittent issues. Furthermore, limited memory cannot be used efficiently.

In a conventional method of generating log data, a designer arbitrarily designs a scenario (for example, collecting specific data at 1-minute intervals) for each function of an in-vehicle control device, and the control device stores data which is collected based on the scenario in a volatile memory (e.g., a random access memory (RAM)) and then store the data stored in the volatile memory in a non-volatile memory (e.g., a flash memory) immediately before power is cut off.

In the conventional method of generating log data, only significant log data cannot be collected because the log data is generated according to a scenario designed by a designer, resulting in a problem that a memory for storing log data cannot be efficiently used.

Furthermore, in the conventional method of generating log data, the log data is generated by use of various types of data, collected according to the scenario designed by the designer, as it is without modification, causing a problem that the memory for storing log data cannot be used efficiently.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method for generating log data which monitor input data and output data corresponding to the input data with respect to a control device of a vehicle, when there is a change in current output data compared to previous output data, generate the log data based on the input data and the current output data, and store the generated log data in a memory, thus collecting only significant log data and efficiently using the limited memory.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus of generating log data includes a controller that monitors input data and output data corresponding to the input data with respect to a control device of a vehicle, and when there is a change in current output data compared to previous output data, generates log data based on the input data and the current output data and a memory that stores the generated log data.

The controller may configure a master packet and a function packet as the log data.

The controller may configure the master packet using data (configuration data) commonly used by specification of the vehicle and each function of the control device and an activation start time of the control device.

The controller may configure the function packet using the input data and the current output data.

The controller may reduce an amount of data through compression and categorical transformation when the input data is numerical input data.

In a case where the input data is categorical input data, the controller may replace the input data with True (1) when the categorical input data satisfies a reference condition and replace the input data with False (0) when the categorical input data does not satisfy the reference condition.

The controller may be configured to determine that there is a change in current output data compared to previous output data when switching is performed from a state in which a dark current is allowed to a state in which the dark current is cut off, or from the state in which the dark current is cut off to the state in which the dark current is allowed.

The controller may be configured to determine that there is a change in current output data compared to previous output data when a power switch is switched from an ON state to an OFF state or when the power switch is switched from the OFF state to the ON state.

The memory may include a volatile memory and a non-volatile memory.

The controller may move the log data stored in the volatile memory to the non-volatile memory when a process for cutting off power to the control device of the vehicle is started.

According to an aspect of the present disclosure, a method for generating log data includes monitoring, by a controller, input data and output data corresponding to the input data with respect to a control device of a vehicle, generating, by the controller, log data based on the input data and current output data when there is a change in the current output data compared to previous output data, and storing, by a memory, the generated log data in the memory.

The generating of the log data may include configuring, by the controller, the master packet using data (configuration data) commonly used by specification of the vehicle and each function of the control device and an activation start time of the control device, and configuring, by the controller, a function packet using the input data and the current output data.

The configuring of the function packet may include performing compression on numerical input data having a degree of importance that does not exceed a reference value when the input data is the numerical input data, and replacing categorical input data having a degree of importance that does not exceed the reference value with binary data when the input data is the categorical input data.

The configuring of the function packet may further include deleting input data that overlaps with input data included in the master packet from among the input data.

The generating of the log data may include determining that there is a change in current output data compared to previous output data when switching is performed from a state in which a dark current is allowed to a state in which the dark current is cut off, or from the state in which the dark current is cut off to the state in which the dark current is allowed.

The generating of the log data may include determining that there is a change in current output data compared to previous output data when a power switch is switched from an ON state to an OFF state or when the power switch is switched from the OFF state to the ON state.

The storing of the generated log data may include storing the generated log data in a volatile memory, and moving the log data stored in the volatile memory to a non-volatile memory when a process for cutting off power to the control device of the vehicle is started.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an exemplary view of a vehicle data logging system to which an exemplary embodiment of the present disclosure is applied;

FIG. 2 is a block diagram showing a configuration of an apparatus of generating log data according to an exemplary embodiment of the present disclosure;

FIG. 3 is a flowchart of a method of generating log data according to an exemplary embodiment of the present disclosure;

FIG. 4 is an exemplary diagram showing a structure of a master packet according to an exemplary embodiment of the present disclosure;

FIG. 5A is a first exemplary diagram illustrating a structure of a master packet according to an exemplary embodiment of the present disclosure;

FIG. 5B is a second exemplary diagram illustrating a structure of a master packet according to an exemplary embodiment of the present disclosure;

FIG. 5C is a third exemplary diagram illustrating a structure of a master packet according to an exemplary embodiment of the present disclosure; and

FIG. 6 is a block diagram illustrating a computing system for performing a method of generating log data according to an exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

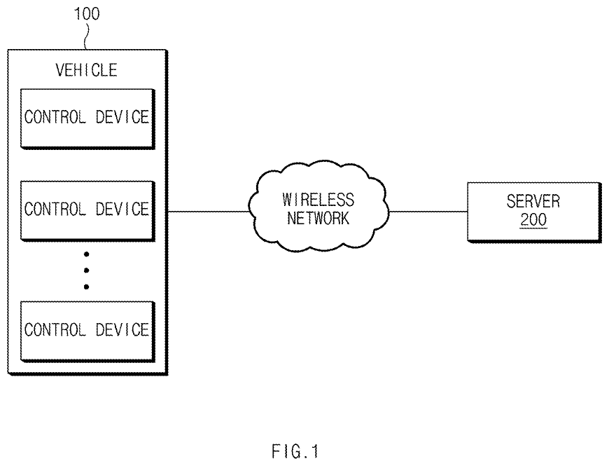

FIG. 1 is a diagram showing an example of a vehicle data logging system to which an exemplary embodiment of the present disclosure is applied.

Referring to FIG. 1, a vehicle data logging system to which an exemplary embodiment of the present disclosure is applied may include a vehicle 100 including a plurality of control devices and a server 200.

The plurality of control devices provided in the vehicle 100 may include various types of control devices, and may include, for example, a Power Domain controller (PDC). The PDC may output first output data allowing dark current or output second output data blocking dark current based on preset input data. Furthermore, the PDC may output third output data for turning on a power switch (e.g., a relay) based on the preset input data or output fourth output data for turning off a power switch. In the instant case, when switching is performed from a state in which the dark current is allowed to a state in which the dark current is cut off, or when a power switch is switched from an ON state to an OFF state or switched from the OFF state to the ON state, this may correspond to an example of a case in which there is a change in the current output data compared to previous output data.

Each of the control devices included in the vehicle 100 may include an apparatus of generating log data according to an exemplary embodiment of the present disclosure.

The server 200 may be implemented as a cloud server, for example, and may communicate with each control device provided in the vehicle 100 through a wireless network. That is, the server 200 may collect log data from each control device provided in the vehicle 100, and may diagnose the state of each control device by analyzing the collected log data.

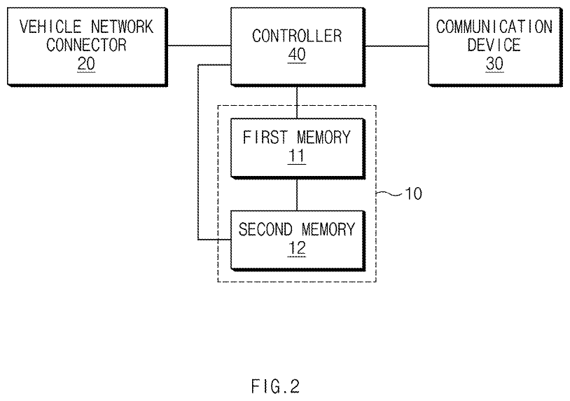

FIG. 2 is a block diagram showing a configuration of an apparatus of generating log data according to an exemplary embodiment of the present disclosure.

Referring to FIG. 2, an apparatus of generating log data according to an exemplary embodiment of the present disclosure may include a memory 10, a vehicle network connector 20, a communication device 30, and a controller 40. In the instant case, according to a method of implementing the apparatus of generating log data according to an exemplary embodiment of the present disclosure, components may be combined with each other as one component, or some components may be omitted.

Hereinafter, the above-mentioned components will be described in detail. First, the memory 10 may store various logics, algorithms, and programs required in a process of monitoring input data and output data corresponding to the input data for the control device of the vehicle, when there is a change in current output data compared to previous output data, generating log data based on the input data and the current output data, and storing the generated log data in the memory 10.

The memory 10 may store a table in which a degree of importance is recorded for each type of input data.

The memory 10 may store a logic for performing transformation of input data when the degree of importance of the input data exceeds a reference value. Here, the transformation may refer to a compression process in the case of numerical input data, and a process of replacing the input data with “True(1)” when a reference condition is satisfied, and replacing the input data with “False(0)” when the reference condition is not satisfied, in the case of categorical input data. For example, numerical input data of 2 bytes may be compressed into 1 byte.

The memory 10 may include at least one type of storage medium of memories such as a flash memory type memory, a hard disk type memory, a micro type memory, and a card type memory (e.g., a Secure Digital card (SC card) or an EXtream Digital card (XD card)), a Random Access Memory (RAM), a Static RAM (SRAM), a Read-Only Memory (ROM), a Programmable ROM (PROM), an Electrically Erasable PROM (EEPROM), a Magnetic RAM (MRAM), and an optical disk type memory.

The memory 10 may include a first memory 11 as a non-volatile memory and a second memory 12 as a volatile memory.

The vehicle network connector 20 may provide a connection interface with a vehicle network. In the instant case, vehicle networks may include a control device Area Network (CAN), a control device Area Network with Flexible Data-rate (CAN FD), a Local Interconnect Network (LIN), FlexRay, Media Oriented Systems Transport (MOST), and Ethernet, and the like.

The communication device 30 is a module that provides a communication interface with the server 200, and may include at least one or more of a mobile communication module, a wireless Internet module, and a short-range communication module.

The mobile communication module may communicate with the server 200 through a mobile communication network which is established according to a technical standard or a communication scheme for mobile communication (e.g., Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), or LTE-A (Long Term Evolution-Advanced) and the like.

The wireless Internet module may be a module for access to wireless Internet and may communicate with the server 200 through Wireless LAN (WLAN), Wireless-Fidelity (Wi-Fi), Wi-Fi Direct, Digital Living Network Alliance (DLNA), Wireless Broadband (WiBro), WiMAX (World Interoperability for Microwave Access (HSDPA), High Speed Downlink Packet Access (HSDPA), High Speed Uplink Packet Access (HSUPA), Long Term Evolution (LTE), Long Term Evolution-Advanced (LTE-A), or the like.

The short-range communication module may support short-range communication with the server 200 using at least one of Bluetooth™, Radio Frequency Identification (RFID), Infrared Data Association (IrDA), Ultra Wideband (UWB), ZigBee, Near Field Communication (NFC), and Wireless USB (Wireless Universal Serial Bus) technologies.

The controller 40 may perform overall control so that each of the above components normally performs its function. The controller 40 may be implemented in a form of hardware or software, or may be implemented in a combination of hardware and software. The controller 40 may be implemented with a microprocessor, but is not limited thereto

The controller 40 may perform a variety of control required in a process of monitoring input data and output data corresponding to the input data with respect to the control device of the vehicle, when there is a change in current output data compared to previous output data, generating log data based on the input data and the current output data, and storing the generated log data in the memory 10. Here, the input data may include, for example, EOL (End Of Line) data including vehicle specification information (e.g., battery type or the like), CAN data or hard wire data that identifies functional operations of the vehicle control device, and the like.

When switching is performed by the control device of the vehicle from a state in which the dark current is allowed to a state in which the dark current is cut off, or when a power switch is switched from an ON state to an OFF state or switched from the OFF state to the ON state, the controller 40 may determine that there is a change in the current output data compared to previous output data.

In the case of numerical input data having the degree of importance that does not exceed the reference value, the controller 40 may reduce the amount of data through compression and categorical transformation, or may replace the numerical input data with binary data (0 or 1). For example, when the numerical input data satisfies the reference condition, the input data may be replaced with True(1), and when the numerical input data does not satisfy the reference condition, the input data may be replaced with False(0). In the instant case, in the case of the numerical input data having the degree of importance that exceeds the reference value, the controller 40 may preserve the numerical input data as it is.

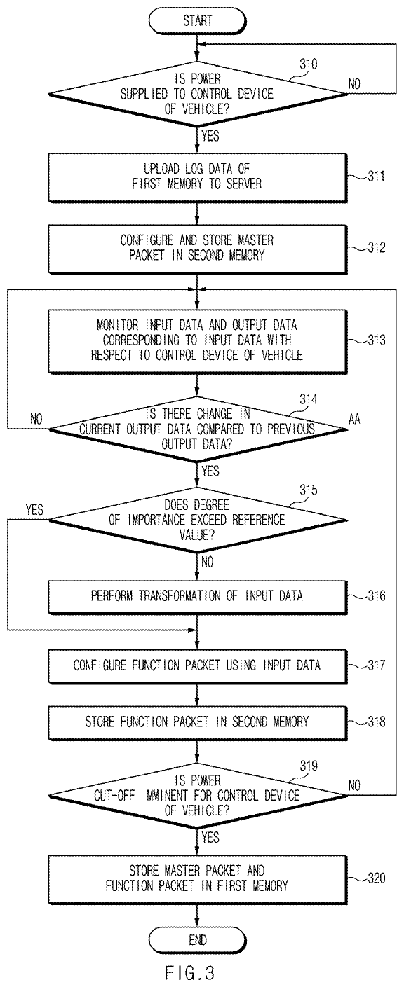

The controller 40 may replace the input data with binary data in the case of categorical input data having the degree of importance that does not exceed the reference value. For example, when the categorical input data satisfies the reference condition, the input data may be replaced with True(1), and when the categorical input data does not satisfy the reference condition, the input data may be replaced with False(0). In the instant case, in the case of the categorical input data having the degree of importance exceeds the reference value, the controller 40 may preserve the categorical input data as it is. Hereinafter, a detailed operation of the controller 40 will be described in detail with reference to FIG. 3.

FIG. 3 is a flowchart of a method of generating log data according to an exemplary embodiment of the present disclosure, and shows a process performed by the controller 40.

First, the controller 40 may upload log data (master packet and function packet) stored in the first memory 11 to the server 200 as power is supplied to a control device of a vehicle (310, 311).

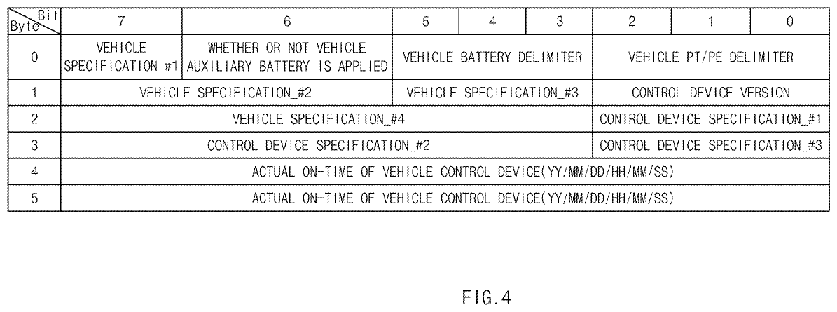

Thereafter, the controller 40 may configure a master packet, and store the configured master packet in the second memory 12 by use of the data (configuration data) commonly used in a specification of the vehicle and each function of the control device and an activation start time of the control device (actual on-time of the control device) (312). An example of a structure of the master packet is shown in FIG. 4.

Thereafter, the controller 40 may monitor input data and output data corresponding to the input data with respect to the control device of the vehicle (313).

Accordingly, the controller 40 may identify whether there is a change in current output data compared to previous output data (314).

When there is a change in the current output data compared to the previous output data, the controller 40 may determine whether a degree of importance of the input data exceeds a reference value (315). In the instant case, there is at least one type of the input data, the controller 40 may determine whether the degree of importance set for each input data exceeds the reference value. Furthermore, before determining whether the degree of importance of the input data exceeds the reference value, the controller 40 may delete input data that overlaps input data included in the master packet from among the input data.

Thereafter, the controller 40 does not perform a separate transformation process on the input data having the degree of importance that exceeds the reference value, but may perform a separate transformation process on input data having the degree of importance that does not exceed the reference value (316).

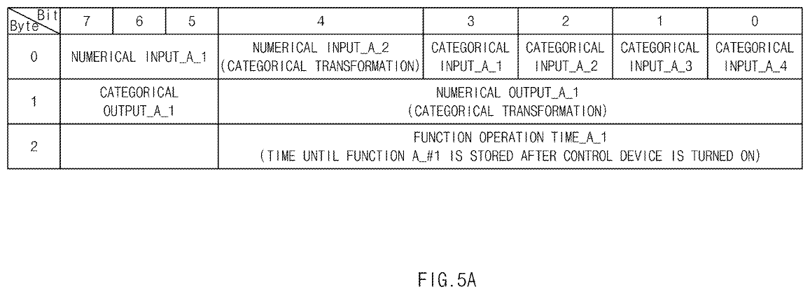

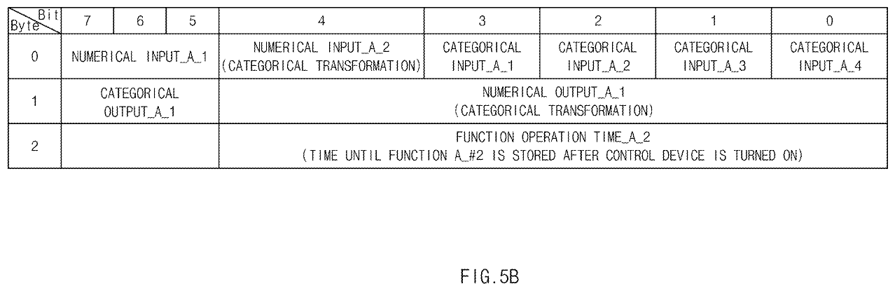

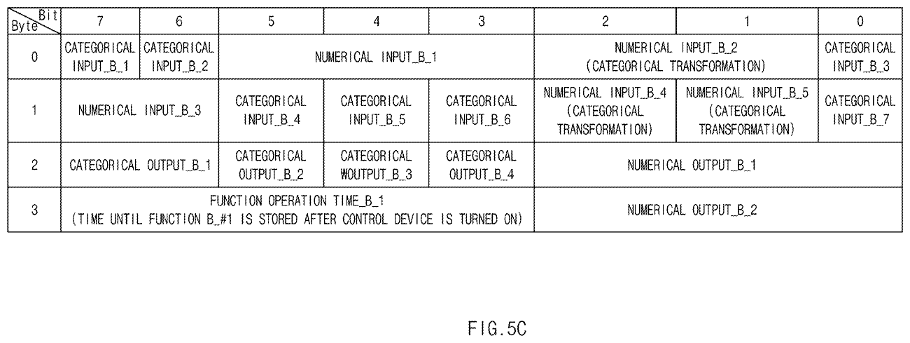

Thereafter, the control unit 40 may configure a function packet by use of the input data (input data that has not undergone the transformation process and/or input data that has undergone the transformation process) (317). Examples of the function packet are shown in FIG. 5A, FIG. 5B, and FIG. 5C.

Thereafter, the controller 40 may store the function packet in the second memory (318).

Thereafter, when the power cutoff to the control device of the vehicle is imminent (319), that is, when the power cutoff procedure for the control device of the vehicle starts, the controller 40 may store, in the second memory 12, the master packet and the function packet stored in the first memory 11 (320). That is, the master packet and the function packet stored in the second memory 12 may be moved to the first memory 11.

Although the controller 40 implemented separately from the control device provided in the vehicle has been referred to as an example in an exemplary embodiment of the present disclosure, the control device may be implemented to perform the operation of the controller 40.

FIG. 4 is an exemplary diagram illustrating a structure of a master packet according to an exemplary embodiment of the present disclosure.

Referring to FIG. 4, a master packet according to an exemplary embodiment of the present disclosure may contain 6 bytes.

In the 0th Byte, the 0th to 2nd bits define a PT(Power Train)/PE(Power Electric) delimiter field of a vehicle, the 3rd to 5th bits define a vehicle battery delimiter field, the 6th bit defines a field indicating whether or not a vehicle auxiliary battery is applied, and the 7th bit defines a field indicating vehicle specification_#1.

In the 1st Byte, the 0th to 2nd bits define a field indicating a version of a control device, the 3rd to 5th bits define a field indicating vehicle specification_#3, and the 6th to 7th bits define a field indicating vehicle specification_#2.

In the 2nd Byte, the 0th to 2nd bits define a field indicating control device specification_#1, the 3rd to 7th bits define a field indicating vehicle specification_#4.

In the 3rd Byte, the 0th to 2nd bits define a field indicating control device specification_#3, and the 3rd to 7th bits define a field indicating control device specification_#2.

The 4th Byte and the 5th Byte respectively indicate actual on-times (YY/MM/DD/HH/MM/SS) of the control devices of the vehicle.

FIG. 5A is a first exemplary diagram illustrating a structure of a function packet according to an exemplary embodiment of the present disclosure.

Referring to FIG. 5A, a function packet according to an exemplary embodiment of the present disclosure is a function A_#1 packet, and may contain, for example, 3 bytes.

In the 0th Byte, the 0th bit defines a field indicating “categorical_input_A_4”, the 1st bit defines a field indicating “categorical_input_A_3”, the 2nd bit defines a field indicating “categorical_input_A_2”, the 3rd bit defines a field indicating “categorical input_A_1”, the 4th bit defines a field indicating “numerical input_A_2” (categorical transformation), and the 5th to 7th bits define a field indicating “numerical input_A_1”. Here, categorical transformation may mean that transformation into categorical data is possible.

In the 1st Byte, the 0th to 4th bits define a field indicating numerical output_A_1 (categorical transformation), and the 5th to 7th bits define a field indicating categorical output_A_1.

In the 2nd Byte, the 0th to 4th bits define a field indicating “function operation time_A_1” (a time until function A_#1 is stored after the control device of the vehicle is turned on).

FIG. 5B is a second exemplary diagram illustrating a structure of a function packet according to an exemplary embodiment of the present disclosure.

Referring to FIG. 5B, a function packet according to an exemplary embodiment of the present disclosure is “function A_#2 packet”, and may contain, for example, 3 bytes.

In the 0th Byte, the 0th bit defines a field indicating “categorical_input_A_4”, the 1st bit defines a field indicating “categorical_input_A_3”, the 2nd bit defines a field indicating “categorical_input_A_2”, the 3rd bit defines a field indicating “categorical input_A_1”, the 4th bit defines a field indicating “numerical input_A_2 (categorical transformation)”, and the 5th to 7th bits define a field indicating “numerical input_A_1”.

In the 1st Byte, the 0th to 4th bits define a field indicating numerical output_A_1 (categorical transformation), and the 5th to 7th bits define a field indicating categorical output_A_1.

In the 2nd Byte, the 0th to 4th bits define a field indicating “function operation time_A_2” (a time until function A #2 is stored after the control device of the vehicle is turned on).

FIG. 5C is a third exemplary diagram illustrating a structure of a function packet according to an exemplary embodiment of the present disclosure.

Referring to FIG. 5C, a function packet according to an exemplary embodiment of the present disclosure is “function B_#1 packet”, and may contain, for example, 4 bytes.

In the 0th Byte, the 0th bit defines a field indicating “categorical input_B_3”, the 1st to 2nd bits define a field indicating “numerical input_B_2 (categorical transformation)”, the 3rd to 5th bits define a field indicating “numerical input_B_1”, the 6th bit defines a field indicating “categorical input_B_2”, and the 7th bit defines a field indicating “categorical input_B_1”.

In the 0th Byte, the 0th bit defines a field indicating “categorical input_B_7”, the 1st bit defines a field indicating “numerical input_B_5 (categorical transformation)”, the 2nd bit defines a field indicating “numerical input_B_4 (categorical transformation)”, the 3rd bit defines a field indicating “categorical input_B_6”, the 4th bit defines a field indicating “categorical input_B_5”, the 5th bit defines a field indicating “categorical input_B_4”, and the 6th to 7th bits define a field indicating “numerical input_B_3”.

In the 2nd Byte, the 0th to 2nd bits define a field indicating “numerical output_B_1”, the 3rd bit defines a field indicating “categorical output_B_4”, the 4th bit defines a field indicating “categorical output_B_3”, the 5th bit defines a field indicating ((categorical output_B_2″, and the 6th to 7th bits define a field indicating “numerical output_B_1”.

In the 3rd Byte, the 0th to 2nd bits define a field indicating “numerical output_B_2”, and the 3rd to 7th bits define a field indicating “function operation time B_1” (a time until function B_#1 is stored after the control device of the vehicle is turned on).

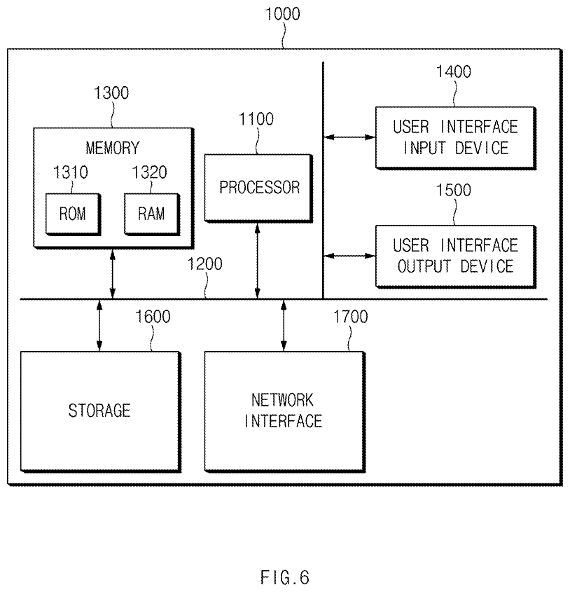

FIG. 6 is a block diagram illustrating a computing system for performing a method of generating log data according to an exemplary embodiment of the present disclosure.

Referring to FIG. 6, the method of generating log data according to an exemplary embodiment of the present disclosure as described above may be also implemented through a computing system. A computing system 1000 may include at least one processor 1100, a memory 1300, a user interface input device 1400, a user interface output device 1500, storage 1600, and a network interface 1700, which are connected to each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a solid state drive (SSD) a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

As described above, the apparatus and method for generating log data according to the exemplary embodiments of the present disclosure monitor input data and output data corresponding to the input data with respect to a control device of a vehicle, when there is a change in current output data compared to previous output data, generate the log data based on the input data and the current output data, and store the generated log data in a memory, collecting only significant log data and efficiently using the limited memory.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of generating log data, the apparatus comprising:
a controller configured to monitor input data and output data corresponding to the input data with respect to a control device of a vehicle, and when there is a change in current output data compared to previous output data, generate the log data based on the input data and the current output data; and
a memory configured to store the generated log data.

2. The apparatus of claim 1, wherein the controller is configured to configure a master packet and a function packet as the log data.

3. The apparatus of claim 2, wherein the controller is configured to configure the master packet using configuration data commonly used by specification of the vehicle and each function of the control device and an activation start time of the control device.

4. The apparatus of claim 2, wherein the controller is configured to configure the function packet using the input data and the current output data.

5. The apparatus of claim 4, wherein the controller is configured to reduce an amount of data through compression and categorical transformation when the input data is numerical input data.

6. The apparatus of claim 4, wherein, in a case where the input data is categorical input data, the controller is configured to replace the input data with True (1) when the categorical input data satisfies a reference condition and replace the input data with False (0) when the categorical input data does not satisfy the reference condition.

7. The apparatus of claim 1, wherein the controller is configured to conclude that there is the change in the current output data compared to the previous output data when switching is performed from a state in which a dark current is allowed to a state in which the dark current is cut off, or from the state in which the dark current is cut off to the state in which the dark current is allowed.

8. The apparatus of claim 1, wherein the controller is configured to conclude that there is the change in the current output data compared to the previous output data when a power switch is switched from an ON state to an OFF state or when the power switch is switched from the OFF state to the ON state.

9. The apparatus of claim 1, wherein the memory includes a volatile memory and a non-volatile memory.

10. The apparatus of claim 9, wherein the controller is configured to move the log data stored in the volatile memory to the non-volatile memory when a process for cutting off power to the control device of the vehicle is started.

11. A method for generating log data, the method comprising:
monitoring, by a controller, input data and output data corresponding to the input data with respect to a control device of a vehicle;
generating, by the controller, the log data based on the input data and current output data when there is a change in the current output data compared to previous output data; and
storing, by a memory, the generated log data in the memory.

12. The method of claim 11, wherein the generating of the log data includes:
configuring, by the controller, a master packet using configuration data commonly used by specification of the vehicle and each function of the control device and an activation start time of the control device; and
configuring, by the controller, a function packet using the input data and the current output data.

13. The method of claim 12, wherein the configuring of the function packet includes:
performing compression on numerical input data having a degree of importance that does not exceed a reference value when the input data is the numerical input data; and
replacing categorical input data having a degree of importance that does not exceed the reference value with binary data when the input data is the categorical input data.

14. The method of claim 12, wherein the configuring of the function packet further includes deleting input data that overlaps with input data included in the master packet from among the input data.

15. The method of claim 11, wherein the controller is configured to reduce an amount of data through compression and categorical transformation when the input data is numerical input data.

16. The method of claim 15, wherein, in a case where the input data is categorical input data, the controller is configured to replace the input data with True (1) when the categorical input data satisfies a reference condition and replace the input data with False (0) when the categorical input data does not satisfy the reference condition.

17. The method of claim 11, wherein the generating of the log data includes determining, by the controller, that there is the change in the current output data compared to the previous output data when switching is performed from a state in which a dark current is allowed to a state in which the dark current is cut off, or from the state in which the dark current is cut off to the state in which the dark current is allowed.

18. The method of claim 11, wherein the generating of the log data includes determining, by the controller, that there is the change in the current output data compared to the previous output data when a power switch is switched from an ON state to an OFF state or when the power switch is switched from the OFF state to the ON state.

19. The method of claim 11,
wherein the memory includes a volatile memory and a non-volatile memory, and
wherein the storing of the generated log data includes:
storing the generated log data in the volatile memory; and
moving the log data stored in the volatile memory to the non-volatile memory when a process for cutting off power to the control device of the vehicle is started.
